(19) United States
(12) Patent Application Publication
(10) Pub. No.: US 2017/0320464 A1
(43) Pub. Date: Nov. 9, 2017

(54) WIRELESS TRANSCEIVER WITH RECALL INDICATOR

(71) Applicant: Gentex Corporation, Zeeland, MI (US)

(72) Inventor: Steven G. Schultz, Holland, MI (US)

(21) Appl. No.: 15/661,091

(22) Filed: Jul. 27, 2017

Related U.S. Application Data
(63) Continuation of application No. 12/915,360, filed on Oct. 29, 2010, now abandoned.

(51) Int. Cl. B60R 25/00

(52) U.S. Cl. CPC B60R 25/00

(57) ABSTRACT

The invention is a wireless control system and method for wireless control of a remote electronic system from a vehicle. A trainable transceiver is configured to receive a feedback signal from a remote electronic system indicating success or failure of a requested operation. The feedback signal, which may include status information, is stored in memory of the wireless control system for retrieval at a later period. In response to the retrieved feedback signal and status, the control system may recall that status information and/or reissue a wireless control signal to the remote electronic system.

### TECHNICAL FIELD

The invention relates to a wireless control system and method for wireless control of a remote electronic system from a vehicle, and in particular, to a wireless control system and method for recalling status information of a remote electronic system from a vehicle.

### BACKGROUND OF THE INVENTION

In the field of wireless control of remote electronic systems, technological advances have been developed to improve convenience, security, and functionality for the user. One example is a trainable transceiver for use with various remote electronic systems, such as security gates, garage door openers, lights, and security systems. A user trains the trainable transceiver by, for example, transmitting a signal from a remote controller in the vicinity of the trainable transceiver. The trainable transceiver learns the carrier frequency and data code of the signal and stores this code for later retransmission. In this manner, the trainable transceiver can be conveniently mounted within a vehicle interior element (e.g., visor, instrument panel, overhead console, etc.) and can be configured to operate one or more remote electronic systems.

Further advances are needed in the field of wireless control of remote electronic systems, particularly in the case of using automotive electronics to control remote electronic systems. As automotive manufacturers are adding increased electronic systems to the vehicle to improve convenience, comfort, and productivity, simplifying the interface and control of these electronic systems is also becoming increasingly important. In addition, as automotive manufacturers are adding increased electronic systems to the vehicle, providing greater and more refined control over more systems is also becoming increasingly important.

The operator of a trainable transceiver often will activate the trainable transceiver to actuate a remote electronic system as a vehicle is either approaching or leaving the location of the remote electronic system. Often, the operator is not able to immediately ascertain whether the actuation of the device was successful. The actuation can fail based on signal interference, incomplete activation of the trainable transceiver, battery/power failures, etc. Unknown failure of the remote electronic system can cause concern, for example where a garage door fails to close as an operator drives away, leaving the garage open and exposed. Accordingly, an operator is often forced to monitor the remote electronic system to ensure successful operation.

In related US Published Application 2006/0158344, the contents of which are hereby incorporated by reference, there is an improved wireless control system and method for wireless control of a remote electronic system from a vehicle, wherein the trainable transceiver is configured to receive a feedback signal from a remote electronic system indicating success or failure of a requested operation. Further, a system and method of customizing the content of the feedback signal provides an operator with status information during an operation. Further still, the transmitter is configured to retransmit a wireless control signal upon receiving a feedback signal indicating a failure.

### SUMMARY OF THE INVENTION

The invention generally relates to an improved wireless control system and method for wireless control of a remote electronic system from a vehicle. The trainable transceiver is configured to receive a feedback signal from a remote electronic system indicating success or failure of a requested operation. The feedback signal, which may include status information, is stored in memory of the wireless control system for retrieval at a later period. In response to the retrieved feedback signal and status, the control system may recall the status information and/or reissue a wireless control signal to the remote electronic system.

In one embodiment of the invention, there is a wireless control system for wireless control of a remote electronic system, including a trainable transceiver circuit configured to transmit a wireless control signal having control data to control the remote electronic system and to receive a wireless status signal including status data from the remote electronic system sent in response to the wireless control signal; a control circuit coupled to the trainable transceiver circuit and configured to control transmission of the wireless control signal and receipt of the status signal through the trainable transceiver circuit; and a memory to store the received wireless status signal.

In another embodiment of the invention, there is a wireless control method for wireless control of a remote electronic system, including transmitting a wireless control signal, from a trainable transceiver circuit, having control data to control the remote electronic system and to receive a wireless status signal including status data from the remote electronic system sent in response to the wireless control signal; controlling transmission, using a control circuit coupled to the trainable transceiver circuit, of the wireless control signal and receiving the status signal through the trainable transceiver circuit; and storing the received wireless status signal in a memory.

In one aspect of the invention, the control circuit is located within an interior of a vehicle.

In another aspect of the invention, the wireless control system further includes at least one user input, when activated, to control the control circuit to retrieve the status signal stored in the memory; and at least one output device to output the status signal retrieved from the memory.

In still another aspect of the invention, upon activation of the at least one user input, the output device outputs the status signal retrieved from the memory if the control circuit determines that a predetermined period has not elapsed.

In yet another aspect of the invention, if the status data output indicates that the remote electronic system has failed to operate in accordance with the control data of the control signal, the control circuit reissues the control signal through the trainable transceiver circuit to the remote electronic system.

In a further aspect of the invention, the output device is one of a display screen, an icon, a mobile device, a vehicle in-dash display, and an audible feedback device when the status data is retrieved from memory.

In still a further aspect of the invention, the icon illuminates in a plurality of respective colors, each color representative of associated status.

In yet a further aspect of the invention, at least one user input is one of a button, switch, knob, dial, voice-actuated input control, mobile device, keyfob, touch screen, multi-controller selection device and wireless transmitter.

In another aspect of the invention, the wireless status signal includes status data, which status data is stored for a predetermined period of time.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of a vehicle having a wireless control system, according to an exemplary embodiment.

FIG. 2 is block diagram of a wireless control system and a remote electronic system, according to an exemplary embodiment.

FIG. 3 is a diagram of a wireless control system mounted to a vehicle visor, according to an exemplary embodiment.

FIG. 4 is a flowchart illustrating a method of training the wireless control system of FIG. 2, according to an exemplary embodiment.

FIG. 5 is a flowchart illustrating a method of recalling status information in the wireless control system of FIG. 2, according to an exemplary embodiment.

### DETAILED DESCRIPTION OF A PREFERRED EMBODIMENT

The invention generally relates to an improved wireless control system and method for wireless control of a remote electronic system from a vehicle. The trainable transceiver is configured to receive a feedback signal from a remote electronic system indicating success or failure of a requested operation. The feedback signal, which may include status information, is stored in memory of the wireless control system for retrieval at a later period. In response to the retrieved feedback signal and status, the control system may recall the status information and/or reissue a wireless control signal to the remote electronic system.

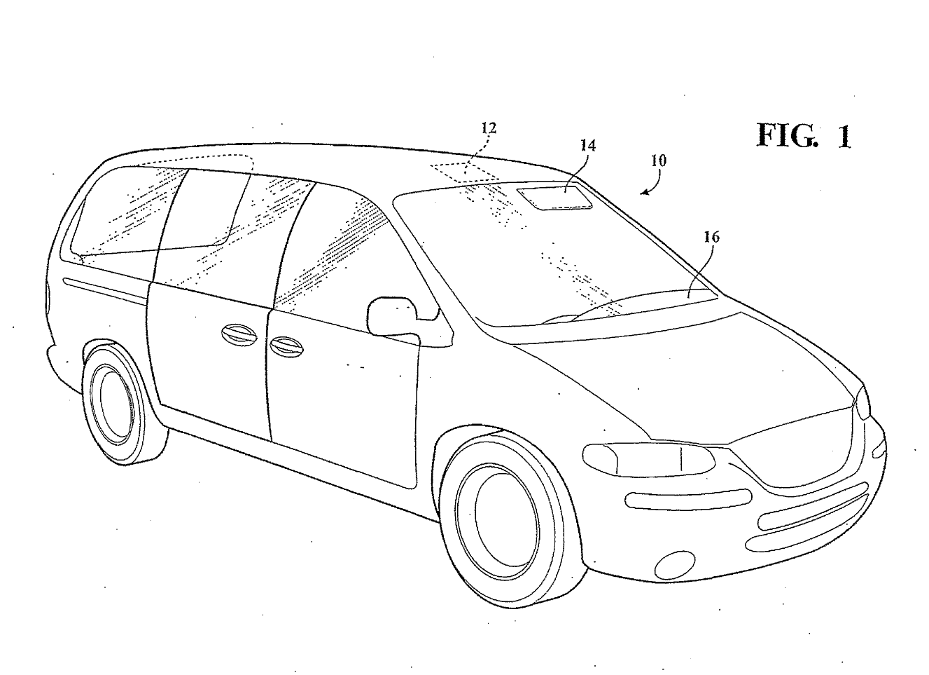

Referring first to FIG. 1, a vehicle 10, which may be an automobile, truck, sport utility vehicle (SUV), mini-van, or other vehicle, includes a wireless control system 12. Wireless control system 12, the exemplary embodiments of which will be described hereinbelow, is illustrated mounted to an overhead console of vehicle 10. Alternatively, one or more of the elements of wireless control system 12 may be mounted to other vehicle interior elements, such as, a visor 14, instrument panel 16, mirror assembly, etc. Alternatively, wireless control system 12 could be mounted to a key chain, keyfob or other handheld device, such as a cell phone, PDA, smartphone or the like.

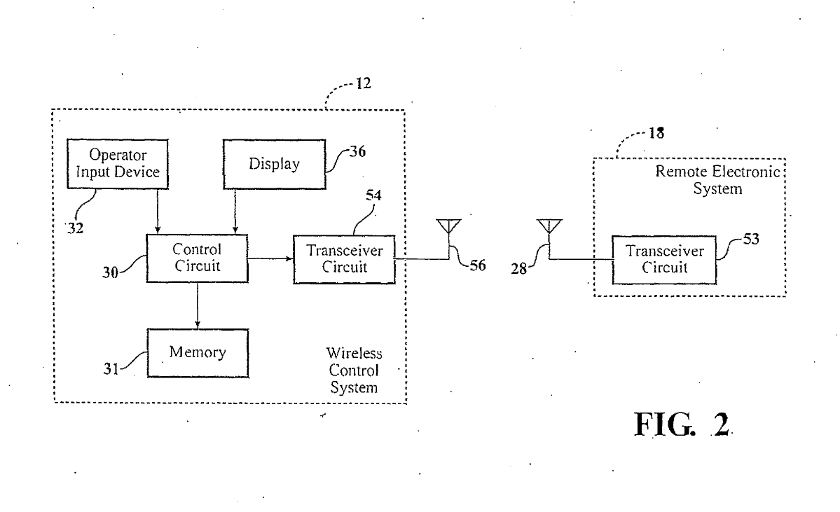

Referring now to FIG. 2, wireless control system 12 is illustrated along with a remote electronic system 18 which may be any of a plurality of remote electronic systems, such as, a garage door opener, a security gate control system, security lights, remote lighting fixtures or appliances, a home security system, etc. Remote electronic system 18 includes a transceiver circuit 53 and an antenna 28. Transceiver circuit 53 includes transmit and/or receive circuitry configured to communicate via antenna 56 with wireless control system 12. Transceiver circuit 53 is configured to receive wireless control signals having control data which will control remote electronic system 18. For example, the control data can cause a garage door opener to open or close a garage door. Transceiver circuit 53 is further configured to transmit wireless status signals having status data indicating the current status of remote electronic system 18.

The status data on the wireless status signal may include a “SUCCESS” status indicative that the control signal was properly received and the control function was successfully executed by remote electronic system 18. The wireless status signal may be sent upon completion of the function specified in the wireless control signal. The status data may also be an “ACKNOWLEDGE” status indicative that a proper wireless control signal was received by transceiver circuit 53. According to an alternative embodiment, remote electronic system 18 can send a plurality of “IN PROCESS” status signals until completion of the operation whereupon a “SUCCESS” or “FAILURE” status signal may be sent. According to yet more alternative embodiments, the wireless status signal may include other information relevant to remote electronic system 18 for transmittal to wireless control system 12. Examples can include whether a garage door is open or closed or moving between open and closed position, whether a security system is armed or disarmed, whether a light is on or off, etc.

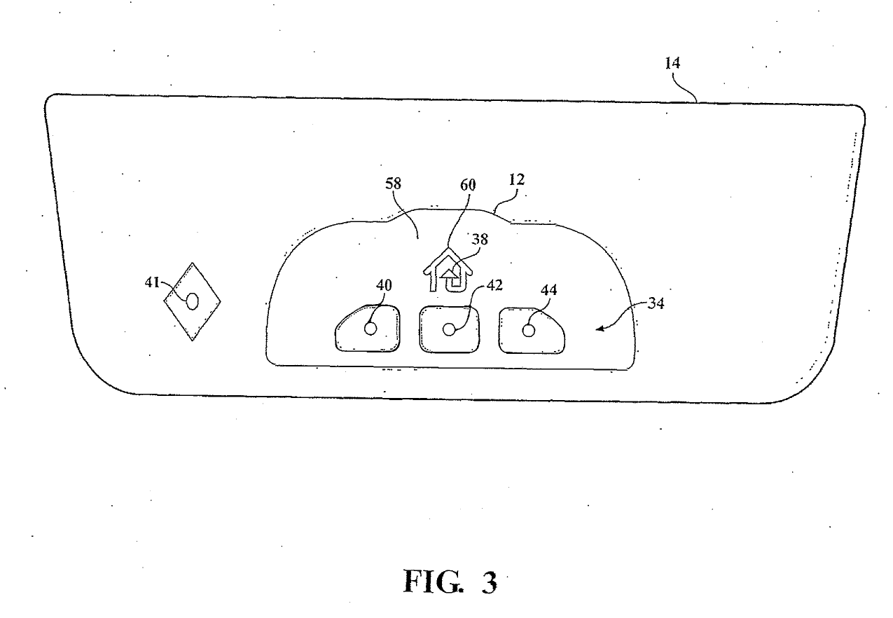

Wireless control system 12 includes a control circuit 30 configured to control the various portions of system 12, to store data in memory 31, to operate preprogrammed functionality, etc. Control circuit 30 may include various types of control circuitry, digital and/or analog, and may include a microprocessor, microcontroller, application-specific integrated circuit (ASIC), or other circuitry configured to perform various input/output, control, analysis, and other functions to be described herein. Control circuit 30 is coupled to an operator input device 32 which includes one or more push button switches 34 (see FIG. 3), but may alternatively include other user input devices, such as, switches, knobs, dials, a voice-actuated input control circuit configured to receive voice signals from a vehicle occupant, etc. and to provide such signals to control circuit 30 for control of system 12.

Control circuit 30 is further coupled to a display 36 which includes a light-emitting diode (LED) or organic LED (OLED), such as, display element 38. Display 36 may alternatively include any other display elements as known in the art, for example but not limited to a liquid crystal display (LCD), a vacuum florescent display (VFD), or other display elements. Display element 38 can include a single multi-colored LED (e.g., green, red, and yellow) or multiple LEDs, each representing a different color.

Wireless control system 12 further includes a transceiver circuit 54 including transmit and/or receive circuitry configured to communicate via antenna 56 with remote electronic system 18. Transceiver circuit 54 is configured to transmit wireless control signals having control data which will control remote electronic system 18. Transceiver circuit 54 is further configured to receive wireless status signals including status information from remote electronic system 18. The wireless control system 12 and remote electronic system 18 may communicate using any wireless standard, including but not limited to WiFi, WiMax, Bluetooth™, infrared, radio frequency (RF), etc.

In operation, wireless control system 12 is configured to receive one or more characteristics of an activation signal sent from an original transmitter. An original transmitter is a transmitter, typically a hand-held transmitter, which is sold with remote electronic system 18 or as an after-market item, and which is configured to transmit an activation signal at a predetermined carrier frequency and having control data configured to actuate remote electronic system 18. For example, the original transmitter can be a hand-held garage door opener transmitter configured to transmit a garage door opener signal at a frequency, such as 355 megahertz (MHz), wherein the activation signal has control data, which can be a fixed code or a cryptographically-encoded code. Remote electronic system 18 is configured to open a garage door, for example, in response to receiving the activation signal from the original transmitter.

Transceiver 54 is configured to receive one or more characteristics of the activation signal from the original transmitter or from another source, which characteristics can include the frequency, control data, modulation scheme, etc. In this embodiment, transceiver 54 is configured to learn at least one characteristic of the activation signal by receiving the activation signal, determining the frequency of the activation signal, and demodulating the control data from the activation signal. Wireless control system 12 can be a Homelink™ trainable transceiver, manufactured by Johnson Controls Interiors LLC, and may be constructed according to one or more embodiments disclosed in U.S. Pat. Nos. 6,091,343, 5,854,593 or 5,708,415, which are herein incorporated by reference in their entirety. Alternatively, wireless control system 12 can receive one or more characteristics of the activation signal by other methods of learning. For example, the one or more characteristics of the activation signal can be preprogrammed into memory during manufacture of wireless control system 12 or can be input via operator input device 32 (which can include a key pad, buttons, etc.). In this manner, wireless control system 12 need not actually receive the activation signal in order to receive characteristics of the activation signal. Wireless control system 12 can receive the characteristics of the signal by any of these methods and store the characteristics of the activation signal in memory.

Transceiver circuit 54 is configured, under control from control circuit 30, to generate a carrier frequency at any of a number of frequencies in the ultra-high frequency range, preferably between 20 and 470 megahertz (MHz), more specifically between 280 and 430 MHz, wherein the control data modulated on to the carrier frequency signal may be frequency shift key (FSK) or amplitude shift key (ASK) modulated, or may use another modulation technique. The control data on the wireless control signal may be a fixed code or a rolling code or other cryptographically encoded control code suitable for use with remote electronic system 18.

Referring now to FIG. 3, an exemplary wireless control system is illustrated coupled to a vehicle interior element, such as a visor. Wireless control system 12 is mounted to visor 14 and includes a molded plastic body 58 having four push button switches disposed therein. Each of the switches includes icons 40, 41, 42, 44, which may be back-lit. Icon 41 represents a “recall” switch that allows an operator to determine the status of a selected icon, as explained in more detail below. Body 58 further includes a logo 60 inscribed in or printed on body 58 and having a display element 38 disposed therewith. During training and operation, display element 38 is selectively lit by control circuit 30 (FIG. 2) to communicate certain information to the user, such as, whether a wireless status signal indicates “SUCCESS” or “FAILURE,” whether the control system 12 is transmitting a wireless control signal, etc. The embodiment shown in FIG. 3 is merely exemplary, and alternative embodiments may take a variety of shapes and sizes, and have a variety of different elements. It is also appreciated that the recall icon 41 may be a separate switch, or integrated into the other icons, or formed in any manner understood to the skilled artisan. For example, depression of icon 40 twice may act as a recall, or depression of two icons, such as icons 40 and 44, simultaneously may act as a recall. Recall functionality may also be integrated into other devices, such as a cell phone, PDA, smartphone, or any other device connected to the wireless system.

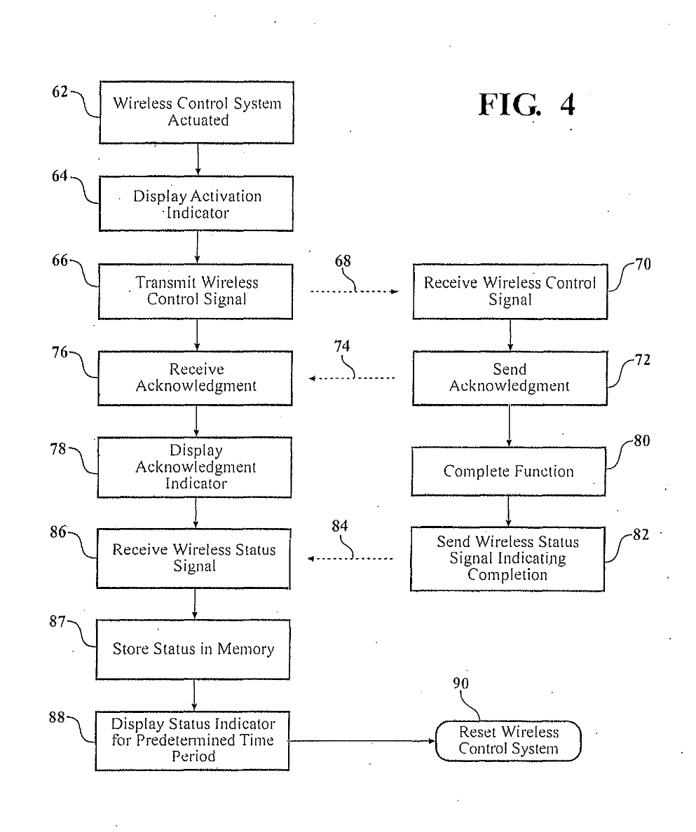

In operation, wireless control system 12 is configured for wireless control of remote electronic system 18. Wireless control system 12 is configured to monitor the status of the control operation and to communicate that status to a user of wireless control system 12. For example, wireless control system 12 can be configured to transmit a wireless control signal from a vehicle to a garage door opener, as will now be described with reference to FIG. 4. FIG. 4 is an exemplary method of receiving a wireless status signal from a remote electronic system in response to transmittal of a wireless control signal. It is understood that one or more of the steps in this exemplary method may be eliminated or rearranged in various embodiments. At step 62, wireless control system 12 is activated. According to an exemplary embodiment, described above with reference to FIG. 3, activation of wireless control system 12 can include depression of a push button switch (e.g., as part of operator input device 32) disposed on a wireless control system 12 attached to a vehicle interior element. According to alternative embodiments, activation can include depression of a button on a handheld wireless transmitter, such as a keyfob or mobile device, use of a voice command, or any other user input to activate wireless control system 12.

According to yet another embodiment, activation can be automated. For example, in a wireless control system 12 including a navigation input device, wireless control system 12 can be configured to transmit the wireless control signal whenever the transmitter is within a predetermined distance to or from the location of the remote electronic system 18. Other examples of automation can include sending the signal based upon timing information, based on time of day information, or any other event-driven or user determined transmittal of the wireless control signal.

At step 64, control circuit 30 can turn on a display, for example turn on display element 38 (e.g., an LED which illuminates RED), that indicates to the user that wireless control system 12 has been activated. Alternative embodiments can include different feedback to the user dependent on the feedback capability associated with wireless control system 12. For example, where wireless control system 12 includes a display capable of displaying alphanumeric characters, the display can include a message such as “SIGNAL SENT,” or an audio system can audibly signal feedback to the user. At step 66, control circuit 30 can transmit a wireless control signal 68 using transceiver circuit 54. The control circuit 30 will then be placed in a “listening” or receiving mode where control circuit 30 is monitoring transceiver 54 to receive an acknowledgement signal from remote electronic system 18. Where an acknowledgment signal is not received within a specified time, such as one second, control circuit 30 can be configured to retransmit the signal without requiring another activation of operator input device 32. Periodically retransmitting wireless control signal 68 will help the system to correct for temporary interference or lack of signal strength in some cases. Control circuit 30 can be configured to retransmit the wireless control signal for a specified number of iterations until receipt by remote electronic system 18 is acknowledged. If the number of iterations exceeds a specified number, the control circuit can communicate a failure to the user of the system by, for example, flashing the red LED.

At step 70, wireless control signal 68 transmitted in step 66 is received by remote electronic system 18 through transceiver circuit 53. Upon receipt, remote electronic system 18 can perform a verification step. Where the signal is valid, remote electronic system 18 can transmit a wireless status signal 74 (e.g., an acknowledgement signal 74) in a step 72 using transceiver circuit 53. In a step 76, wireless control system 12 can receive acknowledgement signal 74. At a step 78, wireless control system 12 can indicate acknowledgement of the wireless control signal to the user of wireless control system 12 by displaying an acknowledgement indicator, such as by turning the red LED yellow and blinking. Upon receiving the acknowledgement signal, wireless control system 12 can be placed in a second listening mode where control circuit 30 is monitoring transceiver 54 to receive a wireless status signal. The second listening mode can include a timing limit where control circuit 30 will indicate an error condition if the wireless status signal is not received within a predetermined time limit. If the wireless status signal is not received within the predetermined time limit, control circuit 30 can use display 36 to indicate a failure condition. According to alternative embodiments, alternative types of feedback can be used to indicate that the wireless control signal was received and acknowledged by remote electronic system 18 or that a failure condition has occurred.

After sending the acknowledgement signal in step 72, remote electronic system 18 can perform the function designated by wireless control signal 68 in a step 80. For example, where remote electronic system 18 is a garage door opener, remote electronic system 18 can open or close the garage door in response to receipt of wireless control signal 68. According to alternative embodiments, wireless control signal 68 can include more robust control over remote electronic system 18. Using the garage door opener example, wireless control signal 68 can include an up-only control signal. An up only signal will only activate the garage door opener if the garage door is not already up. If the garage door is up, remote electronic system 18 can be configured to do nothing.

Following completion of the function in step 80, remote electronic system 18 can be configured to transmit a wireless status signal 84 in a step 82. Wireless status signal 84 can be a message indicating that remote electronic system 18 attempted to perform the function. Where the remote electronic system 18 has the capability to verify the success of an operation, remote electronic system 18 can await completion of the operation and then send wireless status signal 84 including information regarding the success or failure of the function or even reasons for failure of the operation. Exemplary information can include garage door closed, garage door open, garage door operation failed, garage door operation failed because of obstruction, etc. In a step 86, wireless control system 12 can receive and interpret wireless status signal 84. The received and interpreted status signal is stored in memory at step 87 for later retrieval by control circuit 30. Where wireless status signal 84 indicates success, wireless control system 12 can display a status indicator which displays a corresponding success status, such as turning the display element LED green for a period to indicate success in a step 88. Following step 88, wireless control system 12 can reset in a step 90.

According to alternative embodiments, feedback to the user of wireless control system 12 can take a variety of different forms including different levels of content. For example, where wireless control system 12 includes an LCD display screen, the display screen can be used to display a message indicative of the status information received from remote electronic system 18. For example, wherein remote electronic system 12 is a garage door opener, the LCD screen can display “Garage Door Close Signal Sent”, “Garage Door Closing”, “Garage Door Closed”, and/or “Garage Door Closing Error” in response to activation of wireless control system 12. According to an alternative embodiment, feedback to the driver of the vehicle can include audible feedback to the user of wireless control system 12. Additionally, status information may be sent via text or multimedia message to a mobile device, such as a cell phone, PDA or smartphone.

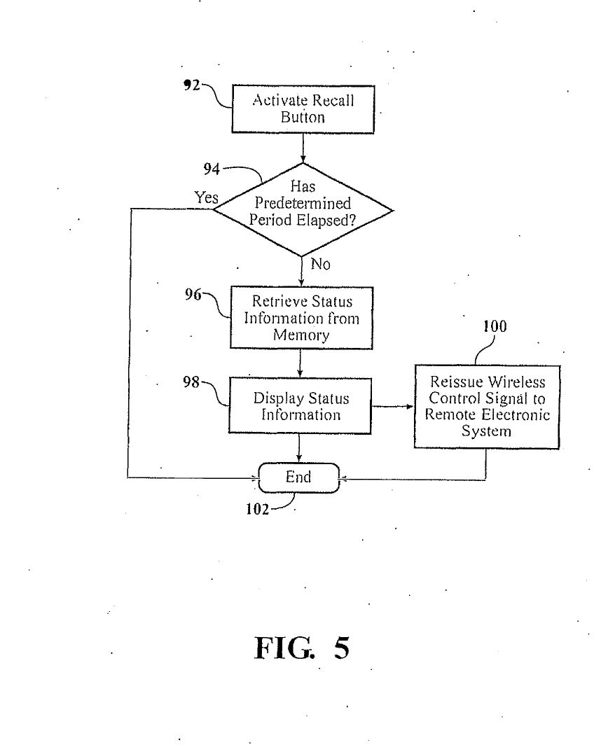

FIG. 5 is a flowchart illustrating a method of recalling status information in the wireless control system of FIG. 2, according to an exemplary embodiment. The illustrated flowchart is an exemplary embodiment in which a driver of a vehicle wishes to recall the status of a previously selected icon to activate remote electronic system 18 via wireless control system 12. For example, the case when a driver pulls into a driveway and activates a remote electronic system, such as a garage door, removes an article from the garage, and proceeds to leave the driveway. In this scenario, the driver may forget whether the remote electronic system 18 was activated and/or whether the activation was successful or a failure. The recall button enables the driver to “recall” the status information stored in memory 31 of the wireless control system 12 once the vehicle has left the driveway, and is no longer within wireless range of the remote electronic system 18.

In one embodiment of the recall button method, a driver activates (e.g. presses) recall icon (button) 41 at step 92. The control circuit 30 determines whether a predetermined period of time has elapsed at step 94. If the predetermined period of time has elapsed, the recall status information has been cleared from memory and the method ends at step 102. If, on the other hand, the predetermined period has not elapsed, then control circuit 30 retrieves (recalls) the status information from memory 31 at step 96. It is understood that the predetermined period of time may be set as a default or selected by a driver of the vehicle. The recalled status information is displayed, as previously explained, at step 98. In one embodiment of the method, the method ends at step 102. In an alternative embodiment of the method, if the status information indicates that a failure occurred, the wireless control system 12 can reissue another control signal to the remote electronic system 18 at step 100. In this case, since the wireless control system 12 is no longer within range of the remote electronic system 18 using the typical RF signal, the system may utilize another type of wireless signal as readily understood. For example, the wireless control system 12 may provide a control signal to a cell phone connected thereto, which in turn may issue the control signal to remote electronic system 18. The wireless control system 12 may then monitor the status of the reissued control signal in a manner similar to that described above.

Advantageously, providing a wireless status signal to a user allows the user to have security in knowing whether the intended operation was a success. For example, where a driver pushes a button to close a garage door, the driver does not have to wait until the garage door is closed before driving away. The wireless control system 12 will indicate if any problem has occurred. This feature also increases security, as some drivers will drive away without having verified that the garage door has fully closed. Where the operation fails, the garage door will remain open for the duration until the driver returns. This system will alert the drivers that there has been a failure so that they can correct the problem. Moreover, the system allows the driver to recall that status of the selected operation at a later time in the event the driver fails to remember whether a selected operation occurred. For example, selection of the recall button (extra button, longer button hold or two quick presses of a single button) recalls whether the button was selected up to a predetermined period of time from leaving the home.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1-18. (canceled)

19. A wireless control system for wireless control of a remote electronic system, comprising:
a transmitter circuit configured to transmit a wireless control signal having control data to control the remote electronic system;
a receiver circuit to receive a wireless status signal including status data from the remote electronic system sent in response to the wireless control signal; and
a control circuit coupled to the transmitter circuit and the receiver circuit and configured to control transmission of the wireless control signal and receipt of the status signal through the receiver circuit,
wherein the status data is sent to a smartphone.

20. The wireless control system of claim 19, wherein the control circuit is located within an interior of a vehicle.

21. The wireless control system of claim 19 and further comprising a memory to store the received wireless status signal.

22. The wireless control system of claim 21, wherein the wireless control system further comprises:
at least one user input, when activated, to control the control circuit to retrieve the status signal stored in the memory; and
at least one output device to output the status signal retrieved from the memory.

23. The wireless control system of claim 22, wherein, upon activation of the at least one user input, the output device outputs the status signal retrieved from the memory if the control circuit determines that a predetermined period has not elapsed.

24. The wireless control system of claim 23, wherein if the status data output indicates that the remote electronic system has failed to operate in accordance with the control data of the control signal, the control circuit reissues the control signal through the trainable transceiver circuit to the remote electronic system.

25. The wireless control system of claim 22, wherein the output device is one of a display screen, an icon, a mobile device, a vehicle in-dash display, and an audible feedback device when the status data is retrieved from memory.

26. The wireless control system of claim 25, wherein the icon illuminates in a plurality of respective colors, each color representative of associated status.

27. The wireless control system of claim 22, wherein the at least one user input is one of a button, switch, knob, dial, voice-actuated input control, mobile device, keyfob, touch screen, multi-controller selection device and wireless transmitter.

28. The wireless control system of claim 19, wherein the wireless status signal includes status data, which status data is stored for a predetermined period of time.

29. A smartphone comprising a wireless control system for wireless control of a remote electronic system, the smartphone comprising:
a transmitter circuit configured to transmit a wireless control signal having control data to control the remote electronic system;
a receiver circuit configured to receive a wireless status signal including status data from the remote electronic system sent in response to the wireless control signal; and
a control circuit coupled to the transmitter circuit and the receiver circuit and configured to control transmission of the wireless control signal and receipt of the status signal through the receiver circuit.

30. The smartphone of claim 29 and further comprising a memory to store the received wireless status signal.

31. The smartphone of claim 30, wherein the wireless control system further comprises:
at least one user input, when activated, to control the control circuit to retrieve the status signal stored in the memory; and
at least one output device to output the status signal retrieved from the memory.

32. The smartphone of claim 31, wherein, upon activation of the at least one user input, the output device outputs the status signal retrieved from the memory if the control circuit determines that a predetermined period has not elapsed.

33. The smartphone of claim 32, wherein if the status data output indicates that the remote electronic system has failed to operate in accordance with the control data of the control signal, the control circuit reissues the control signal through the trainable transceiver circuit to the remote electronic system.

34. The smartphone of claim 31, wherein the output device is one of a display screen, an icon, a mobile device, a vehicle in-dash display, and an audible feedback device when the status data is retrieved from memory.

35. The smartphone of claim 34, wherein the icon illuminates in a plurality of respective colors, each color representative of associated status.

36. The smartphone of claim 31, wherein the at least one user input is one of a button, switch, knob, dial, voice-actuated input control, mobile device, keyfob, touch screen, multi-controller selection device and wireless transmitter.

37. The smartphone of claim 36, wherein the wireless status signal includes status data, which status data is stored for a predetermined period of time.
